(19) United States
(12) Patent Application Publication
(10) Pub. No.: US 2012/0282886 A1
(43) Pub. Date: Nov. 8, 2012

(54) SYSTEMS AND METHODS FOR INITIATING A DISTRESS SIGNAL FROM A MOBILE DEVICE WITHOUT REQUIRING FOCUSED VISUAL ATTENTION FROM A USER

(76) Inventor: David Amis, Durango, CO (US)

(21) Appl. No.: 13/159,596

(22) Filed: Jun. 14, 2011

Related U.S. Application Data
(60) Provisional application No. 61/482,666, filed on May 5, 2011.

(51) Int. Cl. H04M 11/04

(52) U.S. Cl. 455/404.2; 455/404.1

(57) ABSTRACT

The disclosure generally relates to systems and methods for allowing a person to activate a distress signal via a portable device, such as a mobile phone, without having to physically look at the portable device. For example, if a victim is being held hostage, attacked, threatened, etc., and cannot use their mobile phone in plain sight of the hostage-takers, the present invention allows the victim to silently activate a distress signal that can be sent to various third-party response providers, such as a 911 dispatch center, a private security/monitoring service and a friends and family network. The distress signal is activated through various software- and/or hardware-based tactile mechanisms and buttons provided on the portable device.

### CROSS-REFERENCE TO RELATED APPLICATIONS

The present application is related to U.S. Non-Provisional patent application Ser. No. 12/862,117, filed on Aug. 24, 2010, which claims the benefit of U.S. Provisional patent application No. 61/236,265, filed on Aug. 24, 2009. The present application further claims the benefit of U.S. Provisional patent application No. 61/482,666, filed on May 5, 2011. The contents of each of the afore-mentioned patent applications are hereby incorporated by reference in their entireties.

### BACKGROUND

1. Field of the Invention

The present invention relates generally to the field of personal safety management, and more specifically, to systems and methods of transmitting a distress signal to a third-party response provider through a mobile device, without requiring the user to have a focused visual attention on the mobile device.

2. Description of Related Art

Recent advances in mobile computing and wireless technology have transformed traditional mobile phones into invaluable tools that help users with not only communicating with others, but also with managing all aspects of their personal lives and business activities. Mobile devices are increasingly being used for personal safety management as well, where mobile devices can be used to capture evidence, thwart potential perpetrators, and transmit an alarm for help.

However, mobile phones are very visually intensive devices, whereby users must look at the device in order to manipulate it. It is very difficult for current mobile devices to be correctly operated while the devices are concealed, unviewable, and inaccessible due to darkness, poor lighting, or intense situations such as an attack or robbery. A user cannot normally discern the current state of the device without looking at it and/or concentrating on manipulating the device, and therefore cannot be sure as to the current location or state of various on-screen buttons and controls at any given time. This makes it difficult to control the device while it is one's pocket, or while one is engaged in a situation or task that prevents one's ability to look at the device.

For example, consider a scenario when a victim is abducted and is being threatened with violence. In the presence of a perpetrator, it is likely that the victim is hesitant to take out their mobile phone in plain sight and call or text for help, since the perpetrator would most certainly escalate violence and/or confiscate or destroy the mobile phone. The victim is only a single call away from help, but ironically remains helpless because they cannot use their mobile phone in plain sight.

Therefore, there is a need for systems and methods that overcome the deficiencies of traditional mobile devices so that users can easily manipulate and operate a mobile device while it is concealed, unviewable, or inaccessible due to darkness, poor lighting, or stressful situations.

### SUMMARY

A communication device that does not require focused visual attention to manipulate, comprising: a communication means located within the casing; and at least one mechanical switch located on the casing, wherein the communication means is configured to transmit a signal to a remote location upon actuation of the mechanical switch.

In another embodiment, the present invention provides a communication device that provides haptic feedback, comprising a handset having a screen; a communication means coupled to the handset; and at least one pressure-sensitive trigger region located on a pre-determined portion of the screen, wherein the communication means is configured to transmit a signal to a remote location upon application of pressure to the trigger region.

In yet another embodiment, the present invention provides a mobile device for personal safety management, comprising a casing; a screen placed adjacent to the casing; at least one switch located on the casing or on the screen, the switch configured to provide tactile feedback; and a communication means located within the casing, the communications means configured to transmit a distress signal to a remote location signal upon receipt of a pre-determined input to the at least one switch.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a schematic of personal safety communications network in accordance with an embodiment of the present invention;

FIG. 2A is a front view of a mobile device with protruding portions in accordance with an embodiment of the present invention;

FIG. 2B is a side view of a mobile device with protruding portions in accordance with an embodiment of the present invention;

FIG. 3A is a front view of a mobile device with protruding shaped portions in accordance with an embodiment of the present invention;

FIG. 3B is an elevated side view of a mobile device with protruding shaped portions in accordance with an embodiment of the present invention;

FIG. 4A is a front view of a mobile device with flush portions in accordance with an embodiment of the present invention;

FIG. 4B is a side view of a mobile device with flush portions in accordance with an embodiment of the present invention;

FIG. 5A is a side view of a mobile device with indented portions in accordance with an embodiment of the present invention;

FIG. 5B is a side view of a mobile device with an indented portion with a button in accordance with an embodiment of the present invention;

FIG. 6A is a front view of a mobile device with a mechanical slide switch in accordance with an embodiment of the present invention;

FIG. 6B is a side view of a mobile device with a mechanical slide switch in accordance with an embodiment of the present invention;

FIG. 7 is a front view of a mobile device with touch-sensitive buttons in accordance with an embodiment of the present invention;

FIG. 8 is a side view of a mobile device with a Braille-type manipulation system in accordance with an embodiment of the present invention;

FIG. 9 is a side view of a mobile device with an access switch in accordance with an embodiment of the present invention;

FIG. 10 is a front view of a mobile device with a dedicated alarm region on the screen in accordance with an embodiment of the present invention;

FIG. 11 is a front view of a mobile device with a dedicated slide region on the screen in accordance with an embodiment of the present invention; and

FIG. 12 is a flowchart illustrating the steps of triggering a distress signal in accordance with an embodiment of the present invention.

### DETAILED DESCRIPTION

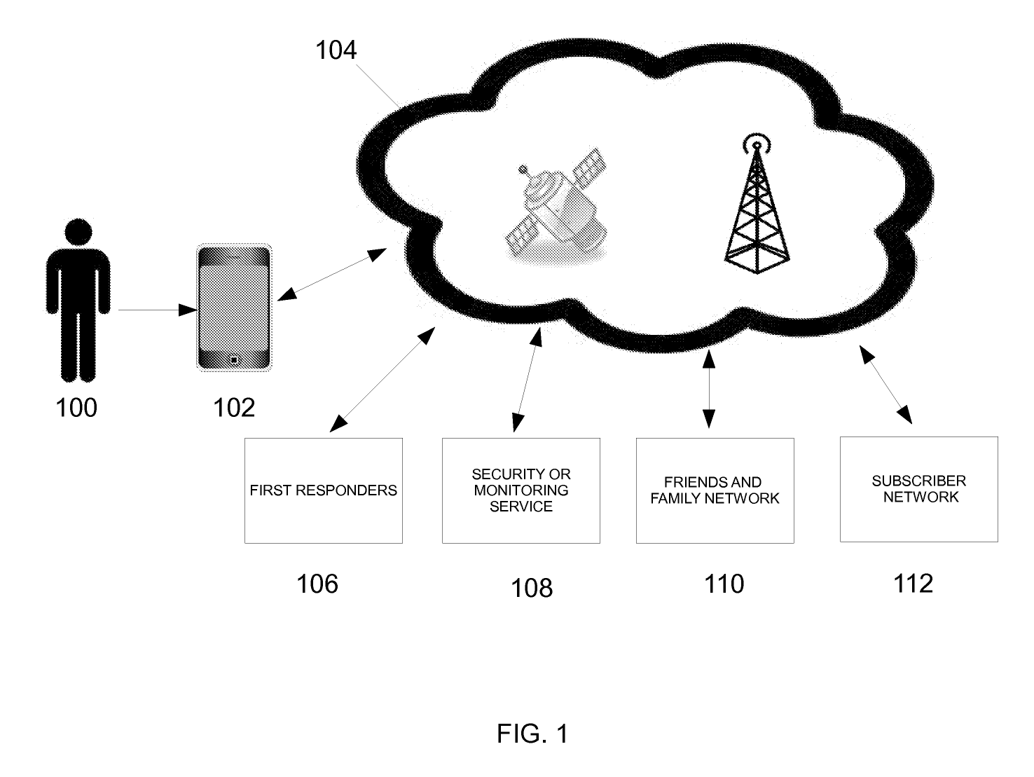

FIG. 1 is a schematic of personal safety communications network in accordance with an embodiment of the present invention. Referring to FIG. 1, the personal safety communications network can include a mobile device 102 which is located on or near the user 100. In a preferred embodiment, the user 100 can be a person, such as a child, elderly person, disabled person, a person living alone, a real estate agent, a mail courier, an undercover law enforcement agent, a postal delivery worker, a teenager, a single female, a disabled person, etc., each having a personalized suite of security services and third-party responses based on their activity, accessibility, vulnerability, and potential occupational hazards.

The mobile device 102 is communicatively coupled to a network 104, which can consist of a satellite communication system, at least one cellular phone tower, a wireless communication node, or any combination thereof. Furthermore, any type of standard or non-standard communication system/protocol which allows for positioning and data transmission can be used.

The network 104 is communicatively coupled to various third-party response providers, such as first responders 106, private monitoring/security providers 108, a user's personal friends/family network 110, and/or a subscriber network 112

The first responders 106 can include a 911 dispatch center, police departments, emergency medical service (EMS) providers, fire and rescue departments, volunteer organizations, and volunteers, including, but not limited to, federal agencies, task forces, non-governmental agencies, relief agencies and workers, and the military.

The user's personal friends/family network 110 can include a pre-determined list of contacts to which a distress signal is automatically transmitted. The contacts can receive a text message, multi-media message (MMS), email, Facetime alert, a phone call with a recorded distress message, live phone call from a 911 or private monitoring center dispatch, live audio from the user's mobile device, a social network notification (i.e., Facebook, MySpace, Orkut, LinkedIn, etc.), an instant messenger notification, or any combination thereof as an indication of the distress signal.

The private monitoring/security providers 108 can offer a subscription-based service that monitors the mobile device 102 as described in co-pending U.S. Non-Provisional patent application Ser. No. 12/862,117, filed on Aug. 24, 2010, entitled “Methods and Systems for Threat Assessment, Safety Management, and Monitoring of Individuals and Groups”, which is incorporated entirely by reference herein.

The subscriber network 112 is a group of users, not necessarily friends and family members of the user 100, but persons that have opted-in or subscribed to a network of users that are willing to provide assistance, crowd a scene, call for help, etc. upon receiving a distress signal from another member of the subscriber network 112. Upon activation of a distress signal by the user 100, a notification is transmitted to all members in the subscriber network 112 that are in a local vicinity of the user 100. The members can then all come to the location of the user 100 in masses in an effort to thwart/startle/disengage the perpetrator. The members can receive a text message, multi-media message (MMS), email, Facetime alert, a phone call with a recorded distress message, live phone call from a 911 or private monitoring center dispatch, live audio from the user's mobile device, a social network notification (i.e., Facebook, MySpace, Orkut, LinkedIn, Twitter, etc.), an instant messenger notification, or any combination thereof as an indication of the distress signal. As described in more detail below, the distress signal can include GPS/location coordinates of the user 100, as well as audio and video data.

The safety communications network depicted in FIG. 1 allows for multi-directional (i.e., two-way, and three-way) communications. That is, a third-party response provider can receive data from the mobile device 102, and can also transmit data to the mobile device 102 via the network 104, as well as to the other third-party response providers.

The mobile device 102 can be a standalone personal safety device, or can be incorporated into a cellular phone, portable music player, keychain, pager, PDA, or other portable communication device. In another embodiment, the mobile device 102 can be worn on the user 100, such as around the user's neck (i.e., necklace or dog collar), ankle (i.e., anklet or ankle bracelet), or as a wristband (i.e., watch strap, watch). In a preferred embodiment, the mobile device 102 is a multi-function device that includes signal reception and transmission capabilities, and includes a cellular phone capability that allows the user 100 to communicate with a remote location.

In a preferred embodiment, the mobile device 102 is an off-the-shelf smart phone or device, such as an iPhone, iPod, iPad, Blackberry, Android, or other similar system. The off-the-shelf device can be loaded with applications or software that enables the off-the-shelf device to act as a mobile device 102 of this invention. For example, a user can download an application from the Internet, Android Marketplace, and/or the Apple Apps Store that includes facilitates the triggering of the distress signal by the user 100 as described below. In an embodiment, the user can pay a one-time or monthly subscription fee to the software provider to gain access to the downloadable applications. Alternatively, the user can download the applications for free, and receive a limited-time or limited-feature access to try the distress signal functionality. The user must then purchase a subscription to “unlock” the full capabilities and have unlimited access to the software application.

In another embodiment, the mobile device 102 is a standalone device that includes hardware features as described below. While software applications may be downloaded or programmed onto the mobile device 102, the casing, screen and physical construction of the device facilitate the triggering of the distress signal by the user 100.

The distress signal can be a data signal indicating an alarm, and can include position data. In an embodiment, the distress signal can also include audio data, so that once the distress signal is activated on the mobile device 102, a microphone on the mobile device 102 can capture and transmit any audible sounds from the user's environment to the third-party response provider in real-time. In yet another embodiment, a camera on the mobile device 102 can automatically be activated once the distress signal is activated. In the event the mobile device 102 is removed from its concealed location (i.e., pocket, purse, handbag, etc.) or becomes more accessible to the user 100 (i.e., the lights are turned on, a stressful situation ends, etc.), any video/image data from the user's environment will automatically be streamed to the third-party response provider in real-time. The audio and video data can also be stored on a memory located on the mobile device 102.

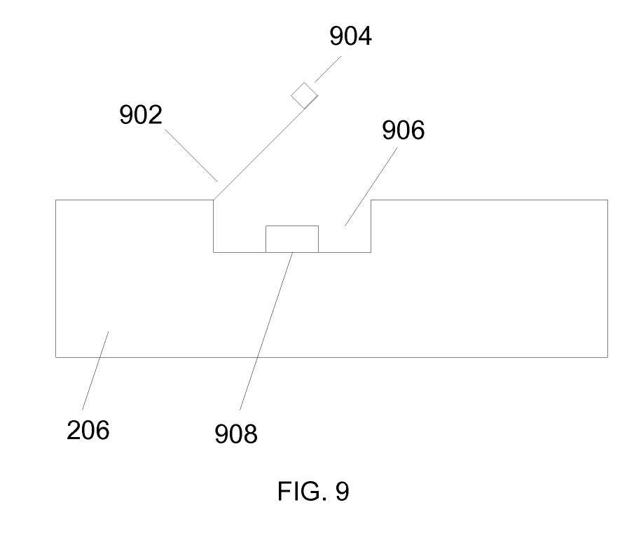

In yet another embodiment, the present invention is incorporated into a traditional land-line phone system, where the receiver does not need to be lifted in order for a distress signal to be transmitted to a third-party response provider. The landline phone base can have a dedicated button or set of buttons through which the user 100 can activate a distress signal. The buttons can be part of the keypad or located on another part of the phone base. For example, the user can enter a pre-determined sequence onto the keypad that triggers a distress signal (assuming that the keypad is on the base and not on the receiver). This embodiment may be applicable to hotel and home settings that do not receive a strong wireless signal, and the only viable option to communicate is a landline phone. In yet another embodiment, the distress signal can be triggered via a hidden switch or “astronaut” switch, similar to that described in FIG. 9 below.

In another embodiment, the mobile device 102 can be configured to search for alternative communication paths in the event that a traditional cellular communication path is not available. For example, if the user 100 is held hostage in a remote location or in a basement that does not receive a cellular phone signal, then the mobile device 102 can determine if there is another wireless connection (i.e., Wi-Fi, RFID, Bluetooth, short-range wireless, etc.) that can be used as a communication path to the various third-party response providers.

According to this embodiment, the mobile device can transmit a special header in the distress signal which the Wi-Fi base station must accept, even if the Wi-Fi network is password protected or encrypted. This ensures that in the presence of a Wi-Fi signal, the mobile device 102 can have guaranteed access to a communication path to a third-party response provider, even if a cellular signal is not available. The special header acceptance can be mandated by federal regulation, local and state laws, provisions in the Homeland Security Act, etc. requiring all Wi-Fi base stations to accept this type of distress signal, even if the Wi-Fi signal is password protected.

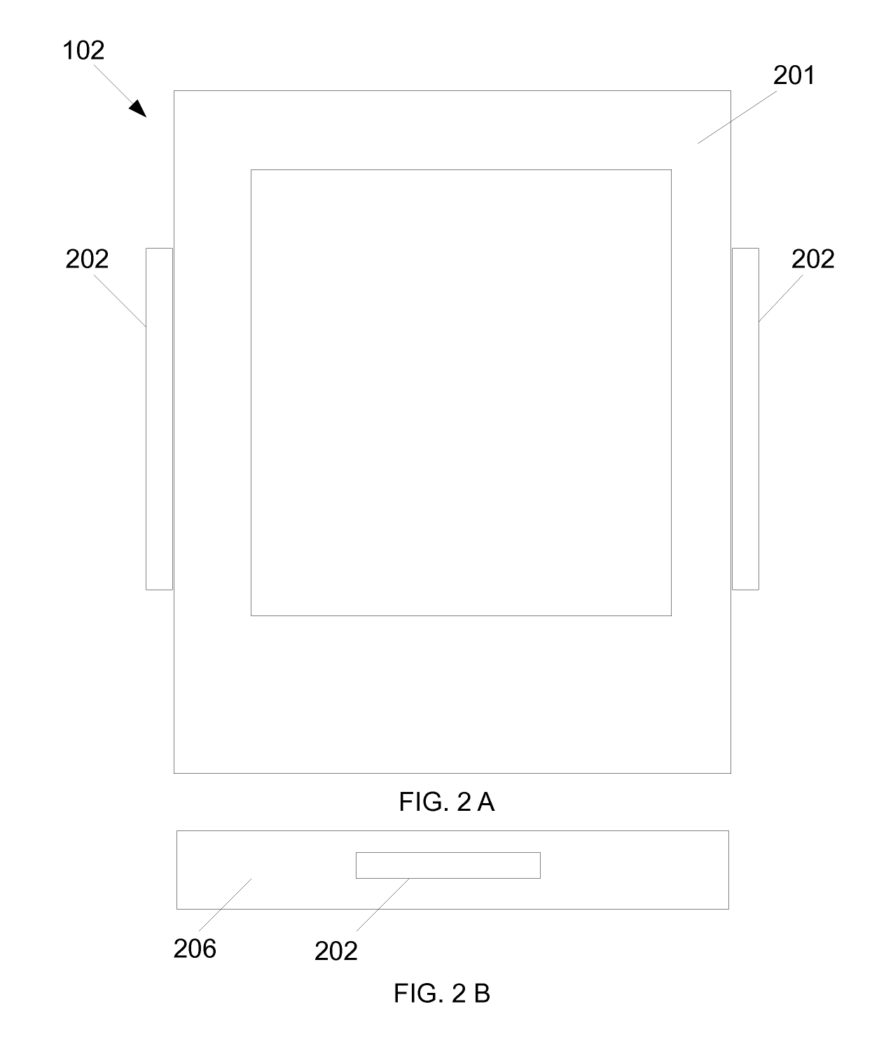

FIG. 2A is a front view of a mobile device 102 with protruding portions in accordance with an embodiment of the present invention. The mobile device 102 can include a casing 201 that has protrusions 202 located on each of the opposite sides of the casing 201. In an embodiment, the protrusions 202 are slightly raised from the casing 201, so that the user 100 can easily locate the protrusions 202 by feel. Upon a simultaneous depression of both protrusions 202, the mobile device automatically transmits a distress signal to a remote location, such as to at least one of the third-party response providers. For example, the user 100 can simply grasp the mobile device 102 and squeezes the protrusions 202 without having to look at the mobile device 102. Thus, the user 100 can activate the distress signal without taking it out of their pocket, purse, handbag, etc.

FIG. 2B is a side view of a mobile device 102 with protruding portions in accordance with an embodiment of the present invention. The protrusions 202 can be located on any side, front, or back portion of the casing 201, and their placement is not limited to the embodiment show in FIGS. 2A and 2B. Furthermore, multiple protrusions can be located on either side of the casing 201.

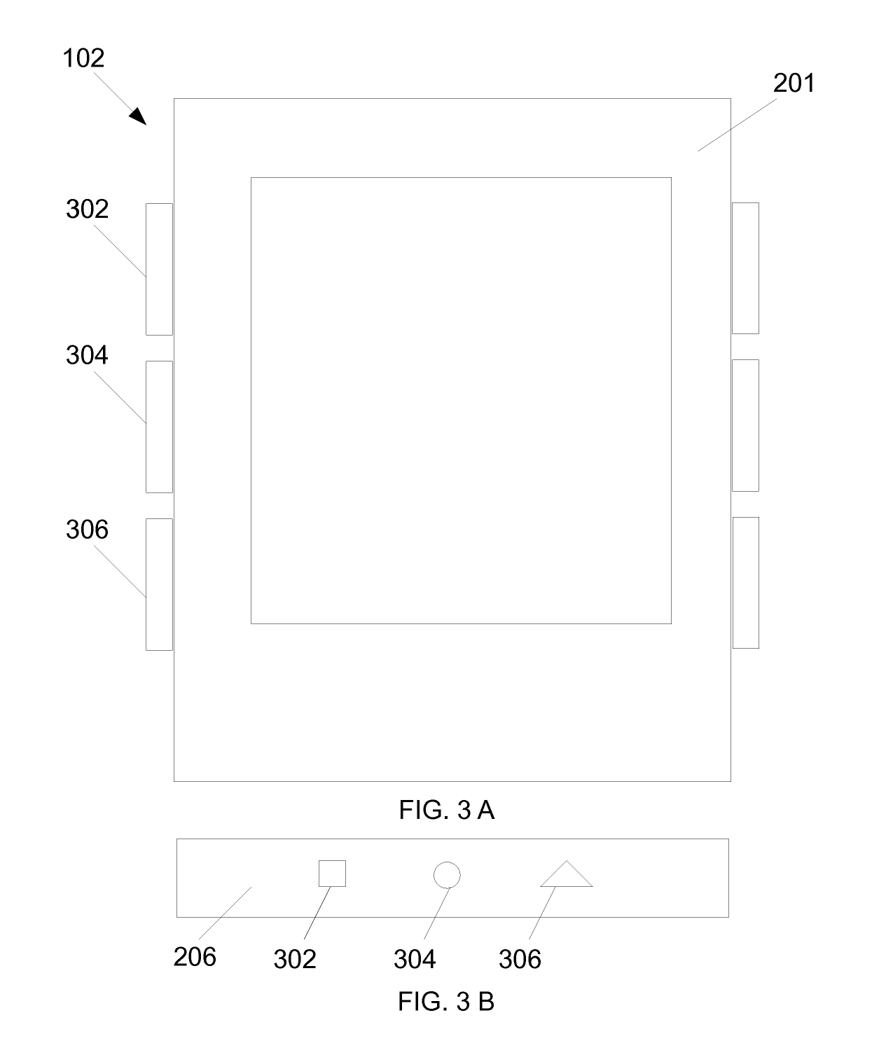

FIG. 3A is a front view of a mobile device with protruding shaped portions in accordance with an embodiment of the present invention. The casing 104 includes multiple protrusions 302-306, each of which has a unique shape as showing in FIG. 3B. For exemplary purposes, indentation 302 can be a square, indentation 304 can be a circle, and indentation 306 can be a triangle. The protrusions 302-306 can be located on a single side of the casing 104, or they can be located on any side, front, or back portion of the casing 201, and their placement is not limited to the embodiment show in FIGS. 3A and 3B.

In an embodiment, the user 100 can input a pre-determined sequence which can trigger a distress signal, such as (1) triangle, (2) square, (3) circle, or (1) circle, (2) circle, (3) square, etc. In this embodiment, the distress signal is only transmitted upon the exact sequence being entered into the mobile device 102, thus preventing accidental transmission of the distress signal.

In another embodiment, each of the different protrusions 302-306 can initiate a different command to the mobile device 102. For example, depression of the square protrusion 302 can initiate a distress signal. Depression of the circular protrusion 304 can activate audio capturing and transmission capabilities. Finally, depression of the triangular protrusion 306 can activate video/image capturing and transmission capabilities.

In yet another embodiment, each different protrusion 302-306 can initiate a different level of a third-party response. For example, depression of the square protrusion 302 transmits a distress signal to a 911 dispatch center. Depression of the circular protrusion 304 transmits a distress signal to a private security company. Finally depression of the triangular protrusion 306 transmits a distress signal to a pre-determined contact list of friends/family members.

In an embodiment, each different protrusion 302-306 can initiate a different type of pre-determined communication to a third-party response provider. For example, in a scenario where a single woman is on a first date, the depression of the square protrusion 302 can transmit a text message to a family member/friend stating, “Please come pick me up from XXX.” The “XXX” can be an address, location, geo-coordinates, landmark, etc. that is automatically inserted into the text message based on the location of mobile device 102.

In another example, in a law enforcement setting, depression of the square protrusion 302 can transmit a message to a police squadron such as “Storm the building!” Depression of the circular protrusion 304 can transmit a message such as “Standby—do not fire.”

The pre-determined communications described above can be modified/changed by the user 100, and/or can be pre-set by the manufacturer or software developer. Furthermore, the shapes listed above are non-limiting, and combination of shapes can be used, such as arrows, rectangles, curves shapes, polygons, diamonds, parallelograms, hearts, crosses, hexagons, heptagons, octagons, etc.

In yet another embodiment, the pre-determined communication can be an automatic wall posting to a user's social media account (i.e., Facebook, MySpace, Orkut, LinkedIn, Twitter, etc.), or it can be an instant messenger notification that is transmitted to all contacts of a user's messenger list.

In another embodiment, the user 100 can customize a 911 or distress protocol. For example, shaking the mobile device 102 can transmit a signal to a 911 dispatch center. Depressing a sequence of buttons or portions of the mobile device 102 can transmit a signal to a security or monitoring service 108. Entering a Braille, numeric, alpha, or alpha-numeric code or password can transmit a signal to the friends and family network 110.

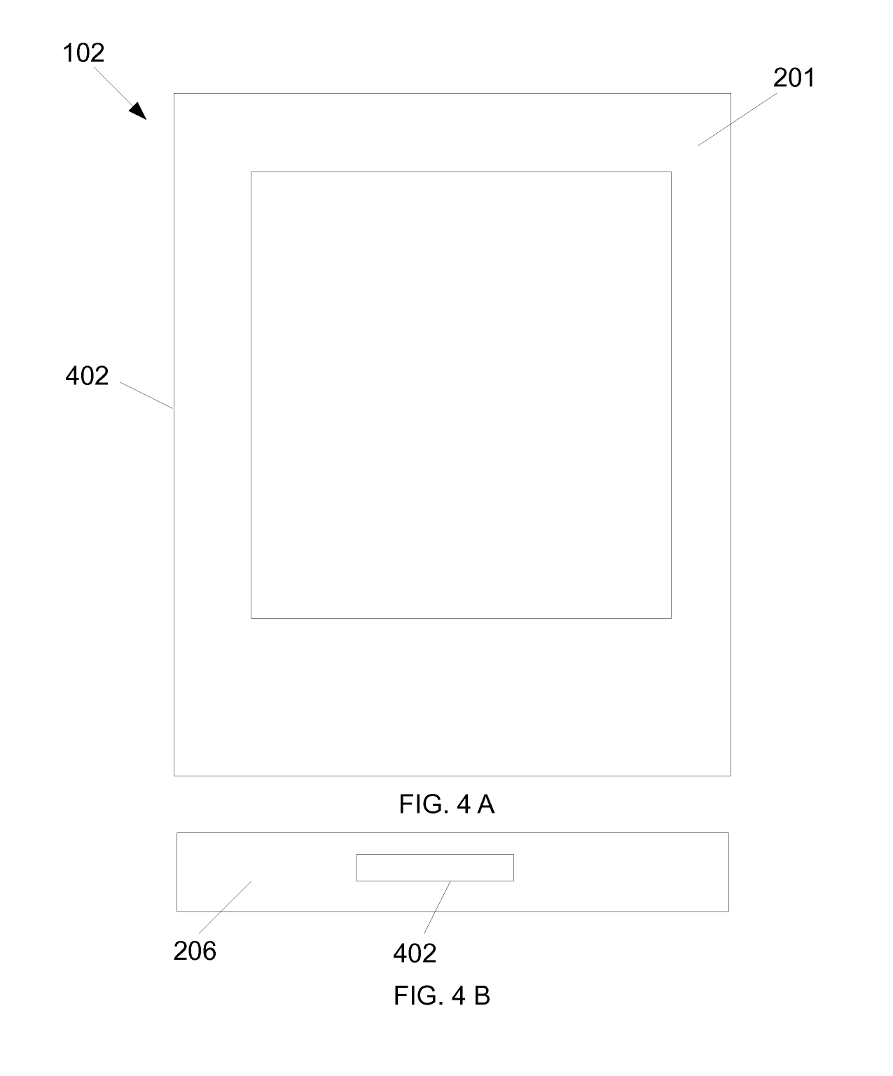

FIGS. 4A and 4B are front and side views, respectively, of a mobile device with flush portions in accordance with an embodiment of the present invention, respectively. The button 402 shown in FIG. 4B is on the same plane as the casing 104, so that it is not protruding or jutting out from the casing 104. Thus, the mobile device 102 has a clean, streamlined look. In this embodiment, the button 402 can be a haptic button, such that when the user 100 places their fingers over the button, the button 402 can vibrate or provide another touch-sensitive sensation to the user 100. The user 100 can easily locate the button 402 without looking at the mobile device 102 by simply feeling around for the haptic sensation. In an preferred embodiment, the entire distress signal activation period should take less than 5 seconds, and more preferably, less than 1.5 seconds.

In an embodiment, the button 402 can be located on any side, front, or back portion of the casing 201, and its placement is not limited to the embodiment show in FIG. 4B. Furthermore, multiple haptic buttons can be located on either side of the casing 201.

In yet another embodiment, multiple haptic buttons, each providing a different sensation can be utilized. For example, a first haptic button can provide a short vibration, while a second haptic button can provide a long vibration. The user 100 could then enter a sequence, such as, for example, two short haptic button presses and one long haptic button press, in order to trigger a distress signal.

In an embodiment, the button 402 can have a surface that is feels different from the casing 201, so that the button 402 can provide a different tactile sensation compared to the casing 201. For example, the button 402 can have a smooth surface, grainy surface, tacky/sticky surface, gel-type surface, soft surface (i.e., made from a foam or other poly-blended material), etc.

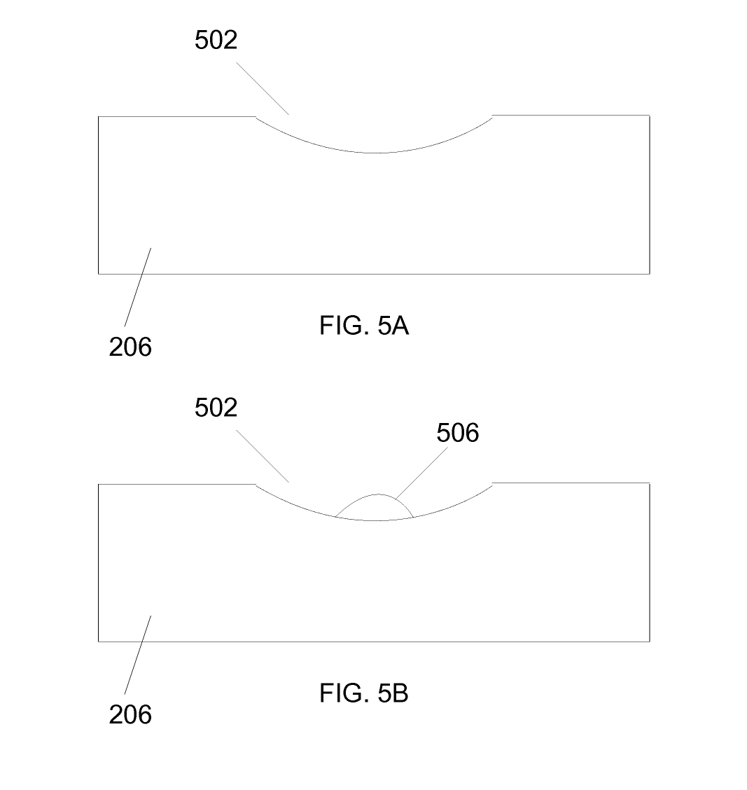

FIG. 5A is a side view of a mobile device with indented portions in accordance with an embodiment of the present invention. The mobile device 102 includes indentations 502 on the casing 201. The indentations 502 can include a touch sensitive layer 504 that can sense the user's finger pressure. Upon sensing the finger pressure, the distress alarm can be triggered. Similar to the other embodiments described above, the indentations 502 can be located on any side, front, or back portion of the casing 201, and its placement is not limited to the embodiment show in FIG. 5A. Furthermore, multiple indentations can be located on either side of the casing 201, and can be used in conjunction with each other so that the user can either simply apply pressure to one or more indentations simultaneously, or in a pre-determined sequence or order to trigger the distress alarm.

In yet another embodiment, the touch sensitive layer 504 can include fingerprint recognition technology. The mobile device 102 can include stored fingerprint data of multiple users. When the distress signal is sent, the fingerprint data of the user 100 is transmitted so that a third-party response provider can know the identity of the user 100.

In another example, the entire screen 204 and/or casing 201 can include fingerprint recognition sensors. In this embodiment, upon activation of the distress signal, any touches to the screen 204 or casing 201 of the mobile device 102 can be recorded, and the captured fingerprints can be sent in real time to a remote location. For example, after a 911 dispatch center can run fingerprints in real-time after receiving a distress signal, in an effort to determine the identity of potential perpetrators who may confiscate or grab the mobile device 102 from the user 100.

In yet another embodiment, upon activation of the distress signal, the screen 204 and/or casing 201 can have means to collect DNA from anyone that touches the mobile device 102. For example, tiny protrusions or sharp points (i.e., nanometer sized protrusions) on the mobile device 102 can collect small skin fragments discreetly and without sensation to the user 100. Law enforcement officials can then use the DNA from the skin fragments as evidence.

FIG. 5B is a side view of a mobile device with an indented portion with a button in accordance with an embodiment of the present invention. In this embodiment, a button, such as a switch, click-button, slide-mechanism, tab, etc. is located within the indentation 502. Upon toggling the button, a distress signal is triggered.

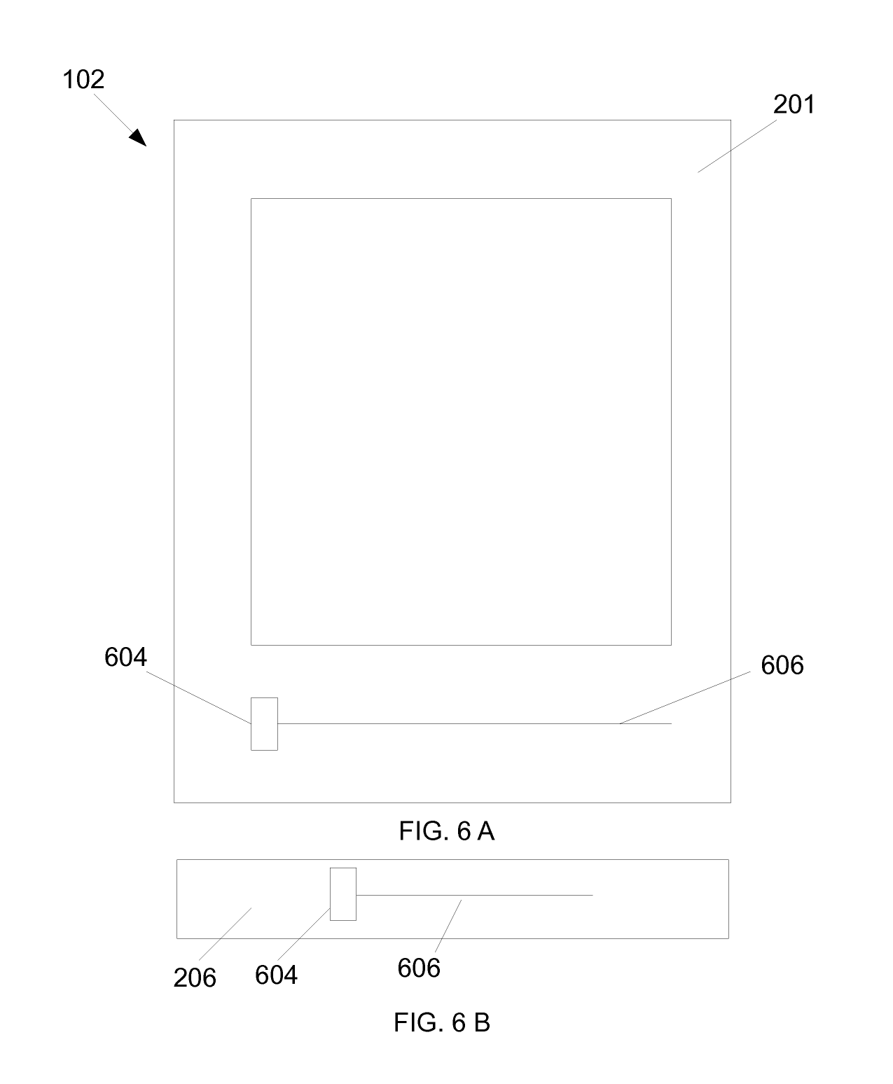

FIG. 6A is a front view of a mobile device with a mechanical slide switch in accordance with an embodiment of the present invention. The mobile device 102 includes a mechanical slide switch 604 on the casing 201. In an embodiment, the slide switch 604 is mounted on a runner 606. When the slide switch 604 is moved from one end of the runner 606 to the opposite end of the runner 606, and back again, within a pre-determined time period, a distress signal is triggered. For example, the distress signal would only be triggered if the user 100 moves the slide switch 604 back and forth two times within a three second period. The number of back-and-forth movements of the slide switch 604, and the time in which these number of movements needs to be completing in, can be pre-determined or pre-set by the user 100 or the mobile device manufacturer. The slide switch 604 and runner 606 can be located on any side, front, or back portion of the casing 201, and its placement is not limited to the embodiment show in FIG. 6A. FIG. 6B is side view of the mobile device 102 with the slide switch 604 located on the side 206 of the mobile device 102.

In yet another embodiment, instead of a slide switch, a rotary dial or turning dial can be used to trigger the distress signal.

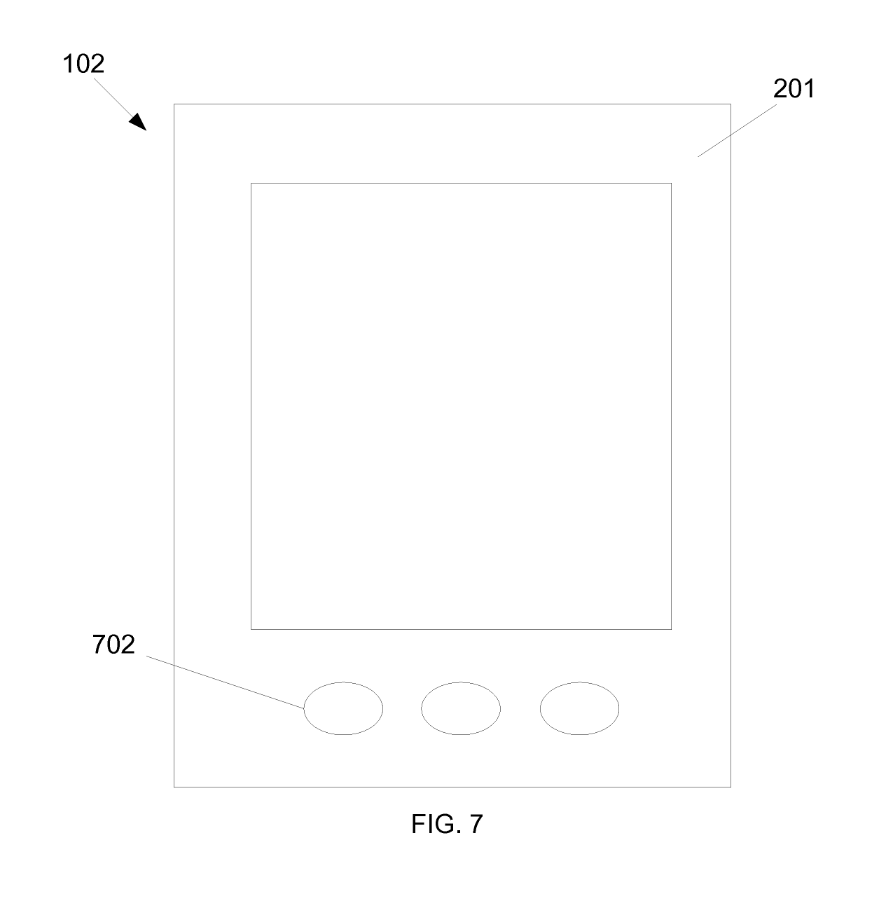

FIG. 7 is a front view of a mobile device with touch-sensitive buttons in accordance with an embodiment of the present invention. The mobile device 102 includes a plurality of touch-sensitive buttons 702 is located on the casing 201. In a preferred embodiment, the plurality of touch-sensitive buttons 702 is arranged in a straight row or column on the casing 201. In operation, the user 100 can slide their finger across the row or column of touch-sensitive buttons 702, effectuating a sliding motion. Such a movement would be difficult to emulate by accidental brushing while the mobile device 102 is in a pocket or purse. In another embodiment, a combination of finger slides and touch gestures can be used in a pre-determined sequence to trigger the distress signal.

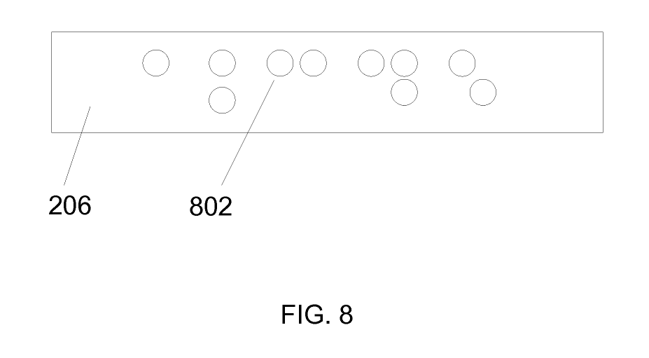

FIG. 8 is a side view of a mobile device with a Braille-type manipulation system in accordance with an embodiment of the present invention. The side 206 of the mobile device 102 (or any other portion of the casing 201) can include a Braille embossed section where the user 100 can trigger a distress signal, or send a message using the Braille alphabet. The message can be in the form of a text message or email that is transmitted from the mobile device 102 to a remote location.

FIG. 9 is a side view of a mobile device with an access switch in accordance with an embodiment of the present invention. The casing 201 of the mobile device 102 includes an access port 906 having a liftable cover 902 supported by a hinge. In an embodiment, the cover 902 includes tactile portions so that a user can locate the cover 902 without looking at the mobile device 102. In yet another embodiment, the cover 902 is slidable, and can slide into the casing 201 to reveal the access port 906. Within the access port 906 is a recess having a button 908. The user 100 can depress the button 908 to trigger a distress signal.

In another embodiment, the access port 906 can include a touch sensitive layer, instead of a button, that can sense the user's finger pressure. Upon sensing the finger pressure, the distress alarm can be triggered.

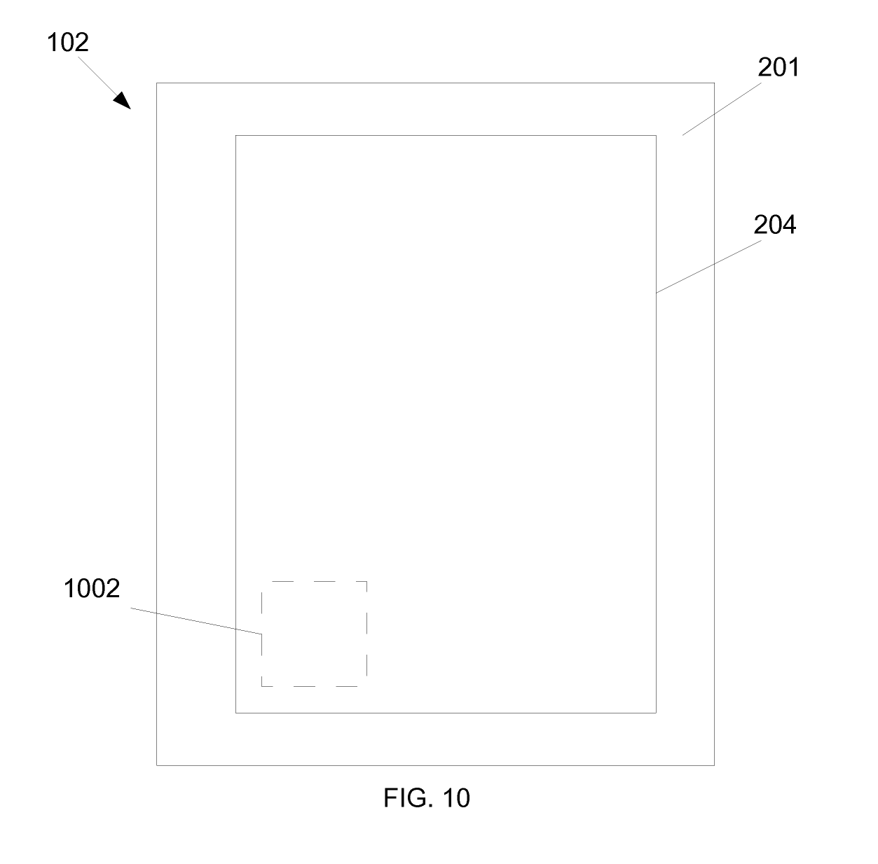

FIG. 10 is a front view of a mobile device with a dedicated alarm region on the screen in accordance with an embodiment of the present invention. The mobile device 102 includes a screen 204. Within the screen 204 is a dedicated region 1002 that the user 100 can touch in a pre-determined fashion to trigger a distress signal. In an embodiment, when the user's finger glides over the dedicated region 1002, a haptic sensation is triggered, indicating to the user 100 that they have located the dedicated region 1002. The user 100 can then enter an activation sequence of inputs, such as three long taps, or two short taps following by one long tap, etc. to trigger the distress signal.

The dedicated region 1002 can be software controlled, allowing for the user 100 or the mobile device manufacturer to set and modify the dedicated region 1002, as well as the activation sequence. In another embodiment, the dedicated region 1002 can be an embedded chip (i.e., hardware) placed within the screen 204. In this embodiment, the dedicated region 1002 is pre-set and cannot be changed. In yet another embodiment, the dedicated region 1002 is not on the screen 204, and can be on any portion of the casing 201 of the mobile device 102.

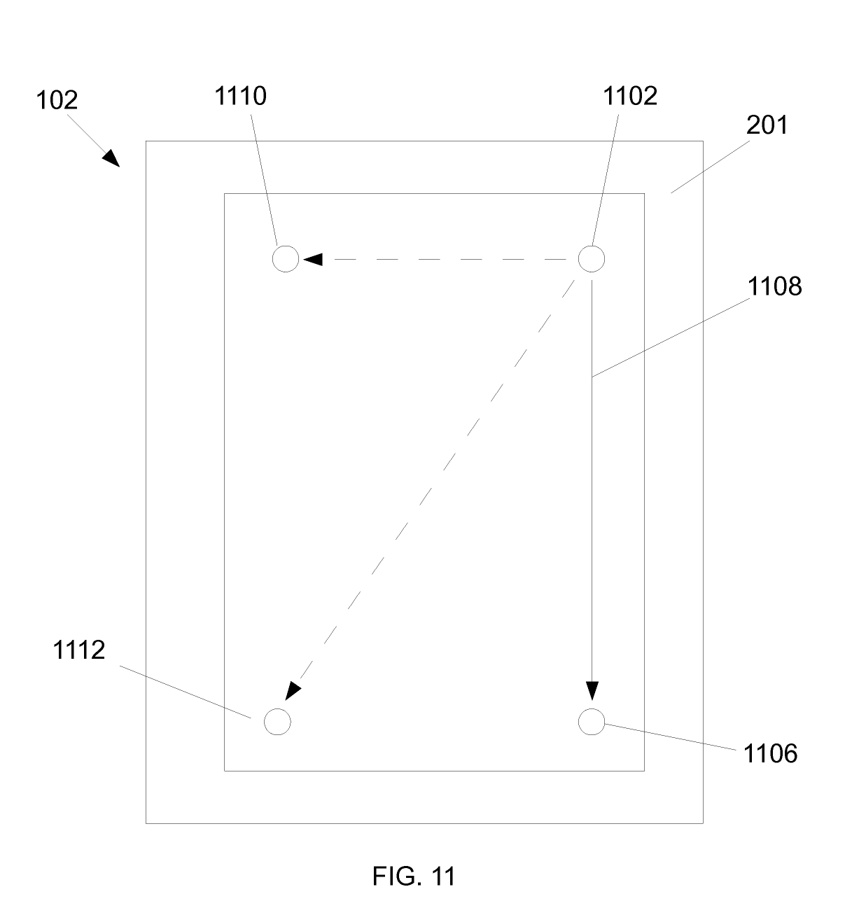

FIG. 11 is a front view of a mobile device with a dedicated slide region on the screen in accordance with an embodiment of the present invention. The mobile device 102 includes a screen 204 that is configured to sense a pre-determined sliding motion in order to trigger a distress signal. In an embodiment, when the user's finger glides over a starting point 1104, a haptic sensation is triggered, indicating to the user 100 that they have located the starting point 1104. In operation, the user 100 can slide their finger 1102 from the starting point 1104 to an ending point 1106 in the direction 1108 to trigger a distress signal. The starting point 1104 and the ending point 1106 can be software controlled, allowing for the user 100 or the mobile device manufacturer to set and modify the sliding region and start and end points. In yet another embodiment, more than two points can be used, such as three points connecting in a Z-shape pattern to trigger the distress signal.

In an embodiment, once the user 100 triggers the distress signal, an audible or visual indicator can be emitted from the mobile device 102. For example, an LED light on the mobile device 102 can be illuminated or can start to blink. In another example, a camera flash on the mobile device 102 can begin to strobe (in an effort to thwart or blind a perpetrator). In another example, a message can automatically be displayed on the screen 204 stating that a distress signal has been initiated. The message can include a logo of a third-party response provider, such as a law enforcement badge, a security company logo/name, etc. In another example, a pre-recorded message, siren, or security company slogan/tagline/message can automatically be played through a speaker on the mobile device 102.

In another embodiment, once the user 100 triggers the distress signal, the mobile device 102 can emit a chemical spray, tagging ink, invisible ink, confetti, or another substance to the surrounding environment.

In another embodiment, upon activation of the distress signal by the user 100, a pre-programmed event signal can be triggered in addition to, or instead of, the distress signal being transmitted to a third-party response provider. For example, the event can be turning on an automobile engine, activating an automobile or home security alarm system, turning on automobile or home lights, opening a garage door, locking or unlocking automobile or home doors and/or windows, activating a security camera or a web camera, etc.

Furthermore, the user 100 can enter a different sequence or touch a different combination of buttons or touch points on the mobile device 102 in order to activate different events. For example, referring to FIG. 11, as mentioned earlier, a vertical finger swipe from starting point 1104 to ending point 1106 can trigger a distress signal. In an embodiment, a horizontal swipe from starting point 1104 to ending point 1110 can trigger an event signal for turning on an automobile engine. Whereas a diagonal swipe from starting point 1112 to ending point 1110 can trigger an event signal to activate a home security alarm system.

In each of the embodiments described in FIGS. 2-11, the mobile device 102 can be in a locked or sleep state in the user's pocket, purse, handbag, etc. in order for the various distress signal triggering mechanisms to be activated. By having the device in a locked state, this would prevent the accidentally triggering of the distress signal.

In another embodiment, the distress signal can be triggered using existing controls on the mobile device 102. For example, while the mobile device 102 is in a locked state, the camera button, volume button, power button, mute button, etc. can be used to trigger the distress signal.

In an embodiment, the mobile device 102 can include accelerometers and/or gyroscope mechanisms to determine its physical orientation. When the orientation is in flux based on accelerometer and gyroscope readings, this can be an indication that the device is in a pocket, purse, handbag, etc., and the mobile device 102 can automatically be placed in a locked mode, thereby enabling the distress signal triggering mechanisms.

In another embodiment, the accelerometer, gyroscope, and GPS sensors can provide a third-party response provider with a location, travel, or movement “trail” that helps third-parties determine when a user 100 came into distress, where they are currently located in relation to the location where the distress signal was activated from, and where the user 100 may possible be going. For example, the accelerometers and GPS sensors can indicate if a user 100 is in a vehicle traveling along an interstate highway, and at what speed.

In another embodiment, destination milestones can be scheduled, whereby upon reaching a predetermined location, the mobile device 102 automatically transmits a notification (via text message, email, phone call, video message, social message posting, etc.) to a third-party response provider. For example, if a single woman is planning a dinner and movie date for the evening, she can set the mobile device 102 to send a notification to a friend once she arrives at the restaurant, and again once she arrives at the movie theater, and finally again once she returns to her home at the end of the evening. Time thresholds can be programmed as well, so that if the woman does not arrive home by midnight, even though the movie was scheduled to end at 11:00 pm, then a distress signal can be transmitted. GPS and/or other location-based sensors can be used to determine the position and location of the mobile device 102.

In yet another embodiment, the mobile device 102 can include a camera. When the camera senses a transition from a lighted environment to a dark environment, indicating that the device has been placed in a pocket or handbag, the mobile device 102 can automatically be placed in a locked mode, thereby enabling the distress signal triggering mechanisms.

In another embodiment, if the mobile device 102 is in a purse, handbag, backpack, etc., the accelerometers and/or gyroscope mechanisms can determine if the user 100 is swinging their bag in a manner consistent with using the bag as a defensive tool. For example, if a woman is being chased or attacked, she may use her purse to beat or fend off the perpetrator. The swinging motion of the purse is likely to be extremely erratic. Upon sensing this erratic motion by the accelerometers and/or gyroscope mechanisms, the mobile device 102 inside the purse can trigger a distress signal.

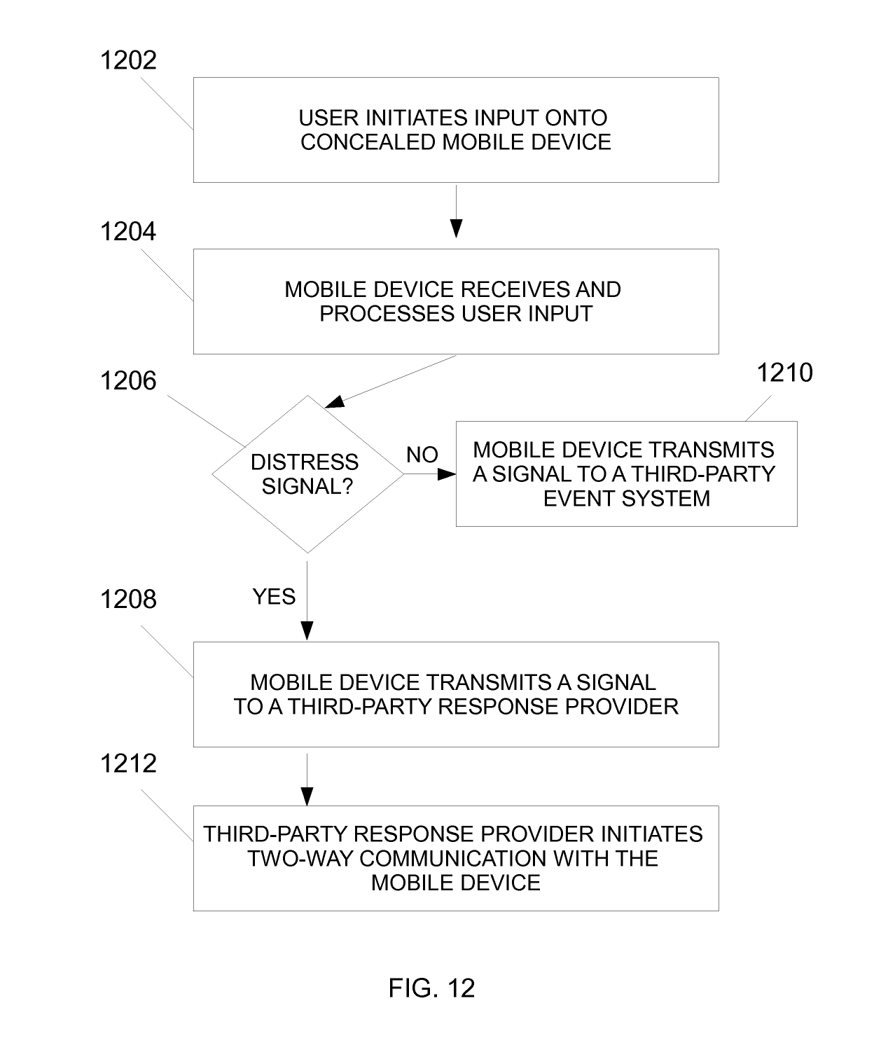

FIG. 12 is a flowchart of the method of triggering a distress signal in accordance with an embodiment of the present invention. In step 1202, the user 100 initiates an input according to one of the aforementioned methods that does not require the user 100 to look at the mobile device 102. Next, in step 1204, the mobile device 102 receives an input signal corresponding to the user input, and subsequently processes the input to determine a corresponding action. In step 1206, the mobile device 102 determines if the input signal corresponds to a distress signal, or to an event signal.

In another embodiment, an algorithm on the mobile device 102, the failure of the user to respond to a third-party response provider verification request, an automatic check-in failure, or the third-party response provider themselves can initiate a command or sequence to trigger the distress signal.

If the input signal corresponds to a distress signal, then in step 1208, the mobile device 102 transmits a distress signal to a remote location, such as to a third-party response provider. The distress signal can include position, audio, and video/image data, as well as any other identifying or information data that can assist the third-party response provider in assessing the user's environment/situation.

Alternatively, if the input signal corresponds to an event signal as described above, then in step 1210, the mobile device 102 transmits an event signal to a third-party event system, such as a home security system, an automobile controller, etc.

In step 1212, the third-party response provider can initiate a two-way communication with the mobile device 102. For example, the third-party response provider can speak through a speaker or loudspeaker on the mobile device 102. In another embodiment, the third-party response provider can trigger an audible alarm or a pre-recorded message stating that the situation is being monitoring, and law enforcement officials are en route to the scene. In yet another embodiment, if the distress signal is transmitted to multiple third-party response providers, each of the response providers can automatically be patched into a conference call with each other. The mobile device 102 is also patched into the conference call, so that the perpetrator and/or user 100 can hear everything that the response providers are doing to assist the user 100. For example, if the distress signal is sent to the subscriber network 112, all of the members that are on their way to the user's location can be patched into a conference call together, along with the mobile device 102.

In another embodiment, upon activation of a distress signal, the mobile device 102 can vibrate, beep, or provide any type of indication to the user 100 that the distress signal has been received by the recipient. In yet another embodiment, the receipt indication can incorporate mechanical features on the mobile device 102. For example, referring to FIG. 3, the after protrusion 302 is depressed to trigger a distress signal, the protrusion 302 can remain in a depressed position until the signal is received by a third-party response provider. Upon receipt of the signal by the response provider, the protrusion then springs up to an extended position. In another embodiment, mechanical buttons, wheels, sliders, and portions of the mobile device 102 can be actuated in different ways, such as spinning, twirling, moving, etc. so that the user 100 can see or feel an indication that the distress signal was received.

In another embodiment, instead of sending an automatic distress signal upon receipt of the aforementioned methods, the mobile device 102 can include a “Release 911” feature, which was described as “911-On-Call” in co-pending U.S. Non-Provisional patent application Ser. No. 12/862,117, filed on Aug. 24, 2010, entitled “Methods and Systems for Threat Assessment, Safety Management, and Monitoring of Individuals and Groups”, which is incorporated entirely by reference herein. Upon feeling uncertain or uneasy about a particular environment or situation, the user 100 can activate a stand-by signal by applying a constant, steady pressure to a certain portion of the mobile device 102. This stand-by signal is transmitted to a third-party response provider.

For example, the user 100 can depress a button, or touch a portion of the mobile device 102, in a pre-determined fashion as described above. As long as the user 100 keeps a constant, steady pressure on this particular portion of the mobile device 102, the stand-by signal is transmitted to a third-party response provider, namely a 911 emergency center or a private monitoring/security provider. Upon receipt of the stand-by signal, the response provider is put on alert that the user 100 is in a potentially threatening situation, but perhaps not necessarily in immediate danger. If the user 100 removes pressure from the portion of the mobile device 102, such as loosening their grip or letting go of the mobile device 102, the third-party response provider requests the user 100 to enter a code (either by input into the mobile device 102, or an audible code) to verify that the user 100 is not in danger. If such as input is not received within a pre-determined period of time, the third-party service provider escalates the situation in order to provide immediate assistance to the user 100.

In yet another embodiment, the accelerometers and/or gyroscope mechanisms can detect if the mobile device 102 is dropped, thrown, or experiences a period of free-fall. Upon sensing such a movement, the mobile device 102 can transmit a stand-by signal to a third-party response provider for verification as described above.

In an embodiment, the mobile device 102 includes a “black box” system, wherein upon destruction of the screen 204 and/or casing 201 of the mobile device 102, the black box continues to record and/or transmit data to a remote location. The black box is similar to an airplane black box, the records data related to an aircraft and is virtually indestructible. In this embodiment, the black box of the mobile device 102 can include its own power supply and communication means that is encased in a tamper-proof housing within the casing 201. Upon destruction of the mobile device 102 or any portion of it thereof, the black box is activated and supplies power to any un-broken sensors, such as the microphone, camera, GPS, etc., and records and/or transmits any collected data to a third-party response provider.

In another embodiment, the distress signal can be triggered by voice commands. For example, the mobile device 102 can have an active microphone, such that the microphone is constantly picking up audible sounds, and the mobile device 102 is constantly processing these sounds in real-time. In the event of an attack, if the user 100 yells certain distress words, such as “Rape”, “Help”, “Attack”, “Burglar”, “Kidnapping”, “Robbery”, etc., the distress signal is automatically triggered. The microphone can be a highly sensitive microphone that can detect sounds even while the mobile device is in a concealed or covered environment.

In another embodiment, the mobile device 102 can include voice recognition software so that only a registered user's voice can activate the distress signal. In another embodiment, a family may choose to register the voices of all family members (e.g. parents, children, elderly grandparents) into the mobile device 102 so that numerous family members can activate it.

In another embodiment, the distress signal can be triggered based on the user's physiological condition. The user 100 can have body sensors communicatively coupled to the mobile device 102 that are specifically tuned to recognize extreme stress consistent with attack, robbery, rape, hostage, and/or kidnapping situations. For example, the mobile device 102 can monitor the heart rate of the user 100. If the user's heart rate becomes abnormally elevated, is erratic, or if no pulse is detected, a distress signal is automatically triggered. In this embodiment, the mobile device 102 is communicatively coupled to the user's body sensors via short-range wireless communication protocols, such as RFID or Bluetooth.

In yet another embodiment, the mobile device 102 can be coupled to an earpiece, such as a Bluetooth headset. The distance between the earpiece and the mobile device 102 can automatically trigger various responses/actions by the mobile device 102. For example, if the distance between the two devices is, for example, 5 feet, a standby-signal can be transmitted to a third-party response provider. If the distance exceeds, for example, 10 feet, then a distress signal can be transmitted to a third-party response provider. This embodiment is useful in a situation where the user 100 is in distress, and cannot reach/access their mobile device 100. The user 100 can simply throw away their earpiece and run away from the location, which can trigger the transmission of a distress signal by the mobile device 102.

While the principles of the disclosure have been illustrated in relation to the exemplary embodiments shown herein, the principles of the disclosure are not limited thereto and include any modification, variation or permutation thereof.

1. A communication device for use in a concealed environment, comprising:
a casing;
a touchscreen coupled to the casing;
a dedicated touchscreen region disposed on the casing;
a haptic mechanism coupled to the touchscreen; and
a communication means located within the casing,
wherein the communication means is configured to transmit a signal to a remote location upon detection of an external pressure to the dedicated touchscreen region in a sliding manner from a first portion of the dedicated touchscreen region to a second portion of the dedicated touchscreen region.

2. The communication device of claim 1, wherein the casing includes a first dedicated touchscreen region and a second dedicated touchscreen region, wherein a simultaneous actuation of both the first dedicated touchscreen region and the second dedicated touchscreen region causes the communications means to transmit the signal.

3. The communication device of claim 1, where the dedicated touchscreen region is a slide region.

4. The communication device of claim 1, wherein at least one Braille character is embossed on the casing.

5. The communication device of claim 1, wherein the signal includes at least one of a position data, an image data, a video data, or an audio data.

6. The communication device of claim 1, wherein the communications means transmits the signal upon detection of the external pressure at multiple areas within the dedicated touchscreen region.

7. The communication device of claim 1, wherein the haptic mechanism is triggered upon detection of the external pressure by the dedicated touchscreen region.

8. The communication device of claim 1, wherein the dedicated touchscreen region is an embedded chip disposed on the touchscreen.

9. The communication device of claim 1, further a second dedicated touchscreen region on a base region of the casing.

10. A communication device that provides haptic feedback, comprising:
a handset having a screen;
a communication means coupled to the handset;
a touchscreen disposed on the handset; and
a dedicated touchscreen portion disposed on the touchscreen,
wherein the communication means is configured to transmit a signal to a remote location upon detection of an external sliding pressure to the dedicated touchscreen portion in a pre-determined shape pattern.

11. The communication device of claim 10, wherein the dedicated touchscreen portion has a starting point and an ending point, and wherein a constant force of pressure from the starting point to the ending point causes the communications means to transmit the signal.

12. The communication device of claim 10, wherein the dedicated touchscreen portion provides a haptic feedback upon application of pressure to the dedicated touchscreen portion.

13. The communication device of claim 10, wherein the communications means transmits the signal upon selection of at least two points within the dedicated touchscreen portion in a pre-determined sequence.

14. The communication device of claim 10, wherein the signal is a distress signal.

15. The communication device of claim 10, wherein the location of the dedicated touchscreen portion can be modified via a software application.

16. A mobile device for personal safety management, comprising:
a casing;
a touchscreen placed adjacent to the casing;
at least one dedicated slide region located on the touchscreen;
a first point and a second point located within the slide region; and
a communication means located within the casing, the communications means configured to transmit a distress signal to a remote location signal upon detection of an external sliding pressure starting at the first point and ending at the second point.

17. The mobile device of claim 16, further comprising a third point located within the slide region, and wherein the communication means is configured to transmit the distress signal upon detection of the external pressure starting at the first point, continuing to the second point, and ending at the third point in a Z-shape manner.

18. The mobile device of claim 16, wherein the dedicated slide region is coupled to a haptic mechanism.

19. The mobile device of claim 16, wherein the communications means is configured to transmit the distress signal via a wireless communication protocol.

20. The mobile device of claim 16, wherein the haptic mechanism is configured to provide a vibration sensation upon detection on an external pressure starting at the first point and ending at the second point.
